(19) United States
(12) Patent Application Publication
(10) Pub. No.: US 2026/0330186 A1
(43) Pub. Date: Oct. 22, 2026

(54) METHOD AND SYSTEM FOR SPECIFYING MODEL ON BASIS OF ARTIFICIAL INTELLIGENCE MODEL INCLUDING PLURALITY OF MODELS

(71) Applicant: LG MANAGEMENT DEVELOPMENT INSTITUTE CO., LTD., Seoul (KR)

(72) Inventor: Ye Muk CHOI, Seoul (KR)

(21) Appl. No.: 19/466,174

(22) Filed: Jan. 30, 2026

Related U.S. Application Data
(63) Continuation of application No. PCT/KR2025/006677, filed on May 16, 2025.

(30) Foreign Application Priority Data
May 17, 2024 (KR) 10-2024-0064552

(51) Int. Cl. G06N 3/045; G06N 3/08

(52) U.S. Cl. CPC G06N 3/045; G06N 3/08

(57) ABSTRACT

A method for specifying a model based on an artificial intelligence model including a plurality of models comprises: performing Mixture of Experts (MoE) architecture-based training based on an artificial intelligence model which is a combination of a plurality of specialized models and a router; obtaining specialized model feature information which is information specifying features of the specialized models based on the MoE architecture-based training; generating a specialized module model matched with the obtained specialized model feature information; obtaining given domain information; detecting specialized model feature information of a feature corresponding to the obtained domain information; extracting a specialized module model that is matched with the detected specialized model feature information; constructing a DMoE model which is an artificial intelligence model which is a combination of the extracted specialized module model and the router; and providing output data for given input data based on the constructed DMoE model.

### CROSS-REFERENCE TO RELATED APPLICATIONS

This application is a continuation of International Patent Application No. PCT/KR2025/006677, filed on May 16, 2025, which claims the benefit of and priority to Korean Patent Application No. 10-2024-0064552, filed on May 17, 2024, the entire disclosures of which are hereby incorporated herein by reference in their entireties.

### BACKGROUND

### Technical Field

The present disclosure generally relates to a method and system for specifying a model based on an artificial intelligence model including a plurality of models. More specifically, some embodiments of the present disclosure relate to a method and system for specifying a model based on a Mixture of Experts (MoE) that implements modularization of a given specialized model within a MoE model.

### Related Art

In general, artificial intelligence (AI) is implemented through multiple AI models and deep learning based thereon.

The AI has been developed to provide various services by considering user's context (e.g., circumstances, environment, and/or intent).

However, when processing specific tasks based on large-volume data, there are limitations arising from considerable computational costs and time required for this.

As a result, the use of AI models in on-device environments which are gaining attention recently is facing certain constraints.

To address this issue, conventional approaches have employed model architectures such as Mixture of Experts (MoE).

The MoE refers to a machine learning model architecture that solves complex problems by combining multiple expert models.

The MoE may include expert models, which are a number of small networks designed to learn different parts and/or different features of given data and perform corresponding data processing operations, and a gating network, which evaluates the performance of each expert model and decides which expert model is most suitable for being allocated a specific task based on given data from the evaluation.

According to the MoE architecture, upon receiving given input data, the gating network determines probabilistic or deterministic task allocation for each expert model. The selected expert models then perform their respective tasks and return the results, thereby enabling data processing for a specific task.

By using the MoE architectures, AI models can enhance overall efficiency and performance by selectively activating specific components when handling complex tasks or large datasets and concentrating computational resources.

However, conventional MoE architectures may require a high level of video random access memory (VRAM) and present considerable challenges in the fine-tuning process.

Moreover, conventional MoE approaches are intended to manage large-sized models efficiently, but conventional MoE approaches have limitations in supporting the efficiency of the remaining resources that are not activated for the given task.

Furthermore, in conventional approaches within the technical field of the related art, services are typically provided using one-size-fits-all AI models, which present problems in quickly and easily achieving AI analysis performance that is most suitable for a given context.

### SUMMARY

An embodiment of the present disclosure may provide a method for specifying a model based on Mixture of Experts (MoE) that implements modularization of a given specialized model within a MoE model.

However, technical objects to be achieved by the present disclosure and embodiments of the present disclosure are not limited to the aforementioned technical objects, and other technical objects may be present.

An embodiment of the present disclosure provides a method in which computing system including a memory and a processor specifies a model based on an artificial intelligence model including a plurality of models, the method comprising: performing MoE (Mixture of Experts) architecture-based training based on an artificial intelligence model which is a combination of a plurality of specialized models and a router (gating network); obtaining specialized model feature information which is information that specifies features of the specialized models based on the performed MoE architecture-based training; generating a specialized module model which is a specialized model that is matched with the obtained specialized model feature information and is independent and discrete; obtaining given domain information; detecting specialized model feature information of a feature corresponding to the obtained domain information; extracting a specialized module model that is matched with the detected specialized model feature information; constructing a DMoE model which is an artificial intelligence model which is a combination of the extracted specialized module model and the router; and providing output data for given input data based on the constructed DMoE model.

In another aspect, the specialized model is an independently pre-trained artificial intelligence model, and the router is an artificial intelligence module that controls a model task.

In another aspect, the obtaining of specialized model feature information comprises: monitoring how a task for each of the plurality of specialized models is allocated by the router during the MoE architecture-based training; and obtaining the specialized model feature information for each of the plurality of specialized models based on the monitored task allocation state.

In another aspect, the specialized model feature information includes first type information which specifies one of preset specialized model feature categories based on user input.

In another aspect, the specialized model feature information includes second type information which specifies a feature of the specialized model in natural language.

In another aspect, the specialized model feature information includes at least one of first type information, which specifies one of preset specialized model feature categories based on user input, and second type information, which specifies a feature of the specialized model in natural language, and includes third type information which further specifies input data and output data of the specialized model.

In another aspect, the generating of a specialized module model comprises: matching the obtained specialized model feature information with a specialized model corresponding to the specialized model feature information; and organizing each specialized model matched with the specialized model feature information separately and discretely in a database.

In another aspect, the domain information is information that defines a domain that specifies at least one feature among data, rules, terminology, problem definitions, and processes for a given task.

In another aspect, the obtaining of the domain information comprises: obtaining given input data; and identifying a domain corresponding to the obtained input data.

In another aspect, the obtaining of specialized model feature information further comprises generating a tag for specifying each task allocated by the router, and the detecting of specialized model feature information corresponding to the domain information comprises detecting specialized model feature information of a feature corresponding to the domain information by comparing the at least one generated tag with the domain information.

In another aspect, the detecting of specialized model feature information corresponding to the domain information further comprises filtering the at least one generated tag based on the time the tag is generated.

Another embodiment of the present disclosure provides a system for specifying a model based on an artificial intelligence model including a plurality of models, the system comprising: at least one memory; and at least one processor that retrieves at least one application stored in the memory and specifies a model based on an artificial intelligence model including a plurality of models, wherein instructions of the processor include instructions for performing the steps: performing MoE (Mixture of Experts) architecture-based training based on an artificial intelligence model which is a combination of a plurality of specialized models and a router (gating network); obtaining specialized model feature information which is information that specifies features of the specialized models based on the performed MoE architecture-based training; generating a specialized module model which is a specialized model that is matched with the obtained specialized model feature information and is independent and discrete; obtaining given domain information; detecting specialized model feature information of a feature corresponding to the obtained domain information; extracting a specialized module model that is matched with the detected specialized model feature information; constructing a DMoE model which is an artificial intelligence model which is a combination of the extracted specialized module model and the router; and providing output data for given input data based on the constructed DMoE model.

A method and system for specifying a model based on an artificial intelligence model including a plurality of models according to some embodiments of the present disclosure may identify a feature of each specialized model within a given MoE model and modularize each specialized model into a compact size that allows for reuse and sharing by reflecting the feature. Thus, it is possible to more accurately, quickly, and efficiently sort and select specialized models that implement a data processing process optimized for a specific domain and to facilitate flexible expansion or reduction of the MoE model accordingly.

Furthermore, a method and system for specifying a model based on an artificial intelligence model including a plurality of models according to an embodiment of the present disclosure may rapidly and flexibly construct a customized MoE model optimized for a specific domain using a specialized model modularized into a reusable and shareable size and accordingly providing output data through efficient task processing. Thus, it is possible to provide a MoE model with enhanced data processing speed and improved inference performance and support a variety of services, thereby promoting improvements in service performance and quality.

The effects of the present disclosure are not limited to the foregoing, and other effects not mentioned herein will be able to be clearly understood by those skilled in the art from the following description.

### BRIEF DESCRIPTION OF DRAWINGS

FIG. 1 illustrates a block diagram of a computing system for implementing a MoE architecture-based model provision service according to an embodiment of the present disclosure.

FIG. 2 illustrates a block diagram of a computing device that implements a MoE architecture-based model provision service according to an embodiment of the present disclosure.

FIG. 3 illustrates a block diagram of a computing device that implements a MoE architecture-based model provision service according to an embodiment of the present disclosure.

FIG. 4 illustrates a block diagram of an AI agent model according to an embodiment of the present disclosure.

FIG. 5 illustrates a flowchart for explaining a MoE model provision method according to an embodiment of the present disclosure.

FIG. 6 illustrates a conceptual diagram for explaining a MoE model provision method according to an embodiment of the present disclosure.

FIG. 7 illustrates a flowchart for explaining a method for specifying a model based on MoE according to an embodiment of the present disclosure.

FIG. 8 illustrates a conceptual diagram for explaining a method for specifying a model based on MoE according to an embodiment of the present disclosure.

FIG. 9 illustrates examples of specialized model feature information according to an embodiment of the present disclosure.

FIG. 10 illustrates a flowchart for explaining a method for providing an AI agent based on a MoE-applied LLM according to an embodiment of the present disclosure.

FIG. 11 shows a conceptual diagram for explaining a method for providing AI agent based on a MoE-applied LLM according to an embodiment of the present disclosure.

### DETAILED DESCRIPTION OF EMBODIMENTS

As the present disclosure may make various changes and have several embodiments, specific embodiments will be illustrated in a drawing and described in a detailed description. Advantages and features of the present disclosure and methods for achieving them will be made clear from the embodiments described below in detail with reference to the accompanying drawings. The present disclosure may, however, be embodied in many different forms and should not be construed as being limited to the embodiments set forth herein. In the following embodiments, terms such as “first”, “second”, etc., are used to distinguish one component from another component rather than for a restrictive meaning. Singular expressions are intended to include plural expressions unless the context clearly indicates otherwise. Terms such as “include”, “comprise”, or “have” indicate the presence of features or components described in the specification, but do not preclude the possibility of addition of one or more other features or components. In the drawings, the sizes of components may be exaggerated or reduced for convenience of explanation. For example, the sizes and thicknesses of the components shown in the drawings are arbitrarily shown for convenience of explanation, and thus the present disclosure is not necessarily limited to those shown in the drawing.

Hereinafter, embodiments of the present disclosure will be described in detail with reference to the accompanying drawings. When described with reference to the drawings, identical or corresponding components will be given the same reference numerals, and redundant description of these components will be omitted.

### Exemplary System for Implementing MoE Architecture-Based Model Provision Service

Hereinafter, an exemplary system for implementing a Mixture of Experts (MoE) architecture-based model provision service that implements modularization of a given specialized model within a MoE model will be described in detail with reference to the accompanying drawings.

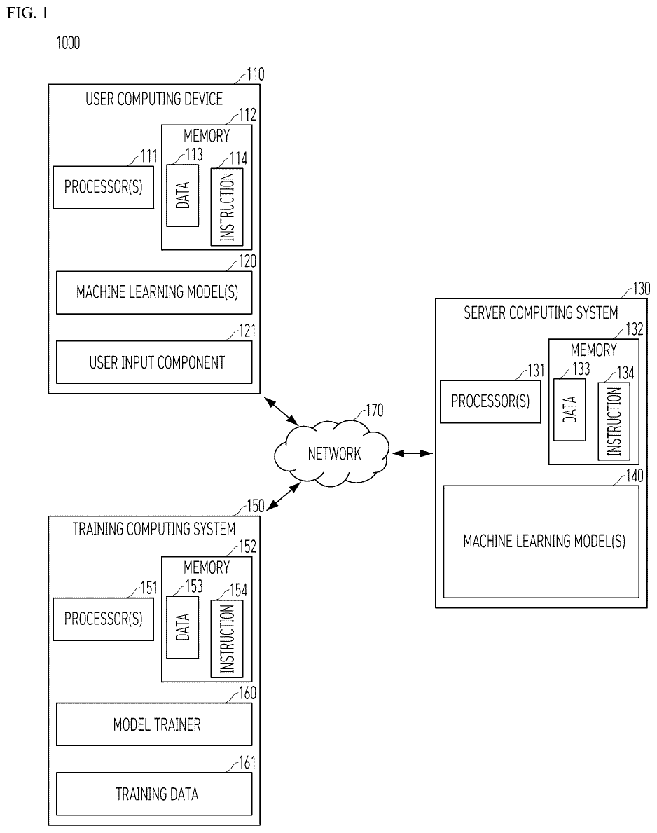

FIG. 1 illustrates a block diagram of a computing system for implementing a MoE architecture-based model provision service according to an embodiment of the present disclosure.

Referring to FIG. 1, a computing system or computer 1000 for implementing a MoE architecture-based-model provision service according to an embodiment of the present disclosure may include a user computing device or user computer 110, a server computing system or server 130, and a training computing system or training computer 150, and one or more of the devices or systems are capable of communicating via a network 170.

The MoE architecture-based-model provision service that implements modularization of a given specialized model in a MoE model according to an embodiment of the present disclosure (1) may be implemented and provided locally by the user computing device 110, (2) may be implemented and provided in the form of a web service by the server computing system 130 communicating with the user computing device 110, or (3) may be implemented and provided by association or combination of the user computing device 110 and the server computing system 130.

In an embodiment, the user computing device 110 and/or the server computing system 130 may train a machine learning model 120 and/or 140 through interaction with the training computing system 150 connected communicatively via the network 170. The training computing system 150 may be a system separated from the server computing system 130 or may be included in or a part of the server computing system 130.

Also, the artificial intelligence model (1) may be directly trained locally the user computing device 110, (2) may be trained through interaction between the server computing system 130 and the user computing device 110 via the network 170, or (3) may be trained by a separate training computing system 150 using various training and learning techniques. In addition, the artificial intelligence model trained by the training computing system 150 may be implemented in such a manner as to be provided and/or updated by being transmitted via the network 170 to the user computing device 110 and/or the server computing system 130.

In some embodiments, the training computer system 150 may be included in or a part of the server computing system 130 or be included in or a part of the user computing device 110.

The user computing device 110 may include all types of computing devices computers, such as smart phone, mobile phone, digital broadcasting device, personal digital assistant (PDA), portable multimedia player (PMP), desktop computer, wearable device, embedded computing device, and/or tablet personal computer (PC).

The user computing device 110 includes at least one processor 111 and memory 112. Here, the processor 111 may include at least one of a central processing unit (CPU), graphics processing unit (GPU), application-specific integrated circuits (ASICs), digital signal processors (DSPs), digital signal processing devices (DSPDs), programmable logic devices (PLDs), field-programmable gate arrays (FPGAs), controllers, micro-controllers, microprocessors, and/or other electrical units for performing functions or a plurality of electrically connected processors.

The memory 112 may include one or more non-transitory/transitory computer-readable storage media such as Random Access Memory (RAM), Read-Only Memory (ROM), Electrically Erasable Programmable Read-Only Memory (EEPROM), Erasable Programmable Read-Only Memory (EPROM), flash memory devices, and magnetic disks, and combinations thereof, and may include web storage of a server that performs a storage function of the memory on the internet. The memory 112 may store data 113 and instructions 114 required for or executable by at least one processor 111 to perform a functional operation such as training an artificial intelligence model or implementing a MoE architecture-based model provision service through the artificial intelligence model.

In one embodiment, the user computing device 110 may store at least one or more machine learning models 120.

In detail, the machine learning models 120 may be various machine learning models such as a plurality of neural networks (e.g., deep neural networks) or other types of machine learning models including non-linear and/or linear models, and may be configured as a combination thereof.

The neural networks may include at least one of feed-forward neural networks, recurrent neural networks (e.g., long short-term memory recurrent neural networks), convolutional neural networks, or/and other types of neural networks.

In one embodiment, the user computing device 110 may receive at least one machine learning model 120 from the server computing system 130 via the network 170, store the machine learning model 120 in the memory 112, and execute the stored machine learning model 120 by the processor 111 to perform a MoE architecture-based model provision service or the like.

In another embodiment, the server computing system 130 may include at least one machine learning model 140 and perform operations using the machine learning model 140, and may provide the user with a MoE architecture-based model provision service by operating in conjunction with the user computing device 110 in a manner that communicates related data to the user computing device 110

For example, the user computing device 110 may perform a MoE architecture-based model provision service via the web in such a way that the server computing system 130 provides output in response to the user's input by using the machine learning model 140.

The artificial intelligence model may be implemented in such a way that one or more of the machine learning models 120 and/or 140 are executed on the user computing device 110, while the remaining models are executed on the server computing system 130.

Furthermore, the user computing device 110 may include at least one input component 121 for detecting user input. For example, the user input component 121 may include a touch sensor (e.g., a touch screen and/or touch pad) that detects the touch of a user input medium (e.g., a finger or stylus), an image sensor that detects motion input from the user, a microphone that detects user voice input, buttons, a mouse, and/or a keyboard. In addition, the user input component 121 may include an interface and an external controller (e.g., mouse and/or keyboard) in case it receives input from the external controller through the interface.

The server computing system 130 includes at least one processor 131 and memory 132. The processor 131 may include at least one of a central processing unit (CPU), graphics processing unit (GPU), application-specific integrated circuits (ASICs), digital signal processors (DSPs), digital signal processing devices (DSPDs), programmable logic devices (PLDs), field-programmable gate arrays (FPGAs), controllers, micro-controllers, microprocessors, and/or other electrical units for performing functions or a plurality of electrically connected processors.

In addition, the memory 132 may include one or more non-transitory and/or transitory computer-readable storage media such as RAM, ROM, EEPROM, EPROM, flash memory devices, and magnetic disks, and combinations thereof. The memory 132 may store data 133 and instructions 134 required for or executable by the processor 131 to perform a functional operation such as training an artificial intelligence model or implementing a MoE architecture-based model provision service through the artificial intelligence model.

In one embodiment, the server computing system 130 may include at least one computing device such as a server or computer. For example, the server computing system 130 may be implemented to operate a plurality of computing devices according to a sequential computing architecture, a parallel computing architecture, or a combination thereof. Additionally, the server computing system 130 may include a plurality of computing devices connected via the network 170.

Moreover, the server computing system 130 may store at least one machine learning model 140. For example, the server computing system 130 may include, as the machine learning model 140, a neural network and/or other multi-layer nonlinear models. Exemplary neural networks may include feed-forward neural networks, deep neural networks, recurrent neural networks, and convolutional neural networks.

The training computing system 150 includes at least one processor 151 and memory 152. The processor 151 may include at least one of a central processing unit (CPU), graphics processing unit (GPU), application-specific integrated circuits (ASICs), digital signal processors (DSPs), digital signal processing devices (DSPDs), programmable logic devices (PLDs), field-programmable gate arrays (FPGAs), controllers, micro-controllers, microprocessors, and/or other electrical units for performing functions or a plurality of electrically connected processors.

In addition, the memory 152 may include one or more non-transitory and/or transitory computer-readable storage media such as RAM, ROM, EEPROM, EPROM, flash memory devices, and magnetic disks, and combinations thereof. The memory 152 may store data 153 and instructions 154 required for or executable by the processor 151 to train an artificial intelligence model.

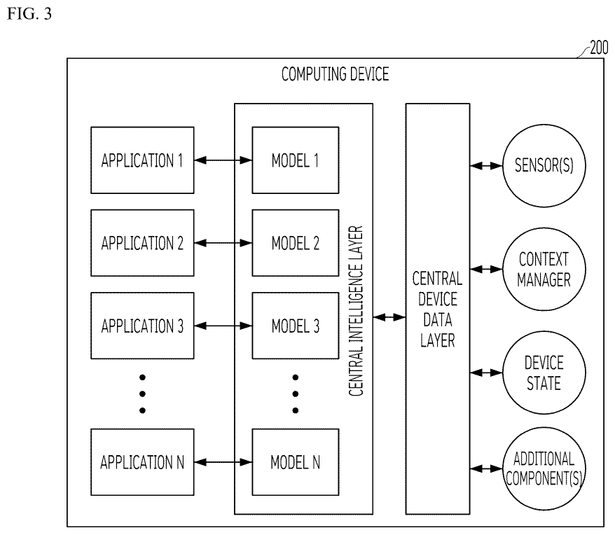

For example, the training computing system 150 may include a model trainer 160 that trains the machine learning model(s) 120 and/or 140 stored in the user computing device 110 and/or the server computing system 130, by using various training or learning techniques such as error backpropagation (e.g., in accordance with an embodiment illustrated in FIG. 3).

By way of example, the model trainer 160 may perform update to one or more parameters of the machine learning model(s) 120 and/or 140 by backpropagation based on a defined loss function.

In some examples, the error backpropagation may include truncated backpropagation through time. The model trainer 160 may perform a number of generalization techniques (e.g., weight decay, dropout, and/or knowledge distillation) to enhance the generalization capability of the machine learning model(s) 120 and/or 140 being trained.

In particular, the model trainer 160 may train the machine learning model(s) 120 and/or 140 based on a series of training data 161. Here, the training data 161 may include different forms of data, such as images, audio samples, and/or text, for example. Examples of image type data include video frames, LiDAR point clouds, X-ray images, computed tomography (CT) scans, hyperspectral images, and/or various other forms of images.

The training data 161 may be provided by the user computing device 110 and/or the server computing system 130. When the training computing system 150 trains the machine learning model(s) 120 and/or 140 on specific data from the user computing device 110, the machine learning model(s) 120 and/or 140 may be characterized as a personalized model.

Additionally, the model trainer 160 includes computer logic utilized to provide desired functionality.

Moreover, the model trainer 160 may be implemented in hardware, firmware, and/or software that controls a general-purpose processor. In one implementation example, the model trainer 160 may include program files stored on a storage device, be loaded into the memory 152, and be executed by one or more processors 151. In another implementation example, the model trainer 160 may include one or more sets of computer-executable data 153 and instructions 154 stored on a tangible computer-readable storage medium, such as RAM, hard disks, or optical or magnetic media.

The network 170 may include, for example, but not limited to, 3GPP (3rd Generation Partnership Project) network, LTE (Long Term Evolution) network, WiMAX (World Interoperability for Microwave Access) network, Internet, LAN (Local Area Network), Wireless LAN (Wireless Local Area Network), WAN (Wide Area Network), PAN (Personal Area Network), Bluetooth network, satellite broadcasting network, analog broadcasting network, and/or DMB (Digital Multimedia Broadcasting) network.

In general, communication via the network 170 may be performed using any type of wired and/or wireless connection, through various communication protocols (e.g., TCP/IP, HTTP, SMTP, and/or FTP), encodings or formats (e.g., HTML and/or XML), and/or protection schemas (e.g., VPN, secure HTTP, and/or SSL).

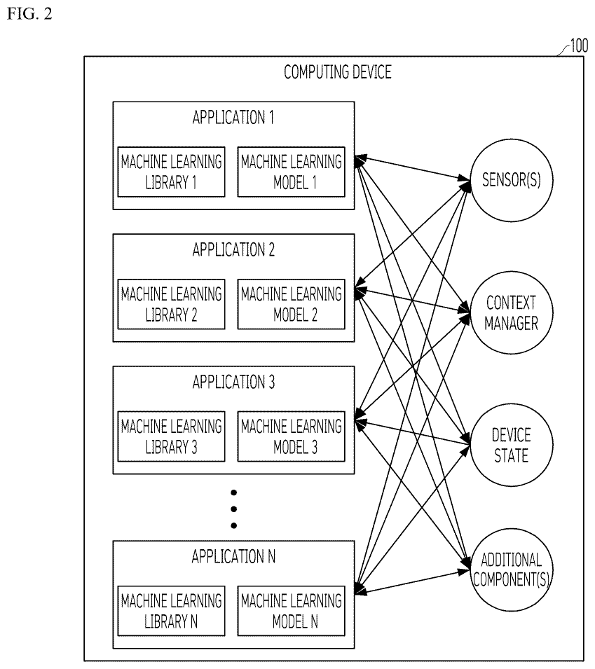

FIG. 2 illustrates a block diagram of a computing device that implements a MoE architecture-based model provision service according to an embodiment of the present disclosure.

Referring to FIG. 2, a computing device 100 included in the user computing device 110, the server computing system 130, and the training computing system 150 may include multiple applications (e.g., Application 1 through Application N). Each application may include a machine learning library and one or more machine learning models. For example, the applications may include applications for image processing (e.g., detection, classification, and/or segmentation), text messaging applications, email applications, dictation applications, virtual keyboard applications, browser applications, and/or chat-bot applications.

In an embodiment, the computing device 100 may include a model trainer 160 for training an artificial intelligence model, and may provide output data based on given input data (e.g., text, speech, image, video, and/or specific sensor-based sensing data) by storing and running the trained artificial intelligence model.

Each application of the computing device 100 may communicate with multiple other components of the computing device 100, such as one or more sensors, a context manager, a device state component, and/or additional components. In one embodiment, each application may use an API (e.g., a public API) to communicate with each device component. In one embodiment, the API used by each application may be specific to that application.

FIG. 3 illustrates a block diagram of a computing device that implements a MoE architecture-based model provision service according to an embodiment of the present disclosure.

Referring to FIG. 3, the computing device 200 includes multiple applications (e.g., Application 1 to Application N). Each application may communicate with a central intelligence layer. For example, the applications may include image processing applications, text messaging applications, email applications, dictation applications, virtual keyboard applications, and/or browser applications. In one embodiment, each application may use an API (e.g., a common API shared across all applications) to communicate with the central intelligence layer (and the models stored therein).

The central intelligence layer may include multiple machine learning models. For example, as illustrated in FIG. 3, one or more of the machine learning models may be provided for each application and managed by the central intelligence layer. In another implementation example, two or more applications may share a single machine learning model. For example, in some implementation examples, the central intelligence layer may provide a single model for all applications. In some implementation examples, the central intelligence layer may be incorporated into the operating system of the computing device 200 or implemented differently.

The central intelligence layer may communicate with a central device data layer. The central device data layer may serve as a centralized data storage location for the computing device 200. As illustrated in FIG. 3, the central device data layer may communicate with multiple other components of the computing device 200, such as one or more sensors, a context manager, a device state component, and/or additional components. In some implementation examples, the central device data layer may use an API (e.g., a private API) to communicate with each device component.

The technologies and components described herein may be applied and make reference to servers, databases, software applications, and other computer-based systems, as well as actions taken and information transmitted to or from systems. It will be appreciated that the inherent flexibility of computer-based systems allows for a wide range of possible configurations, combinations, divisions of tasks, and functionality between and from components. For example, the processes described herein may be implemented using a single device or component, or multiple devices or components working in combination. Databases and applications may be implemented on a single system or distributed across multiple systems. Distributed components may operate sequentially or in parallel.

### Artificial Intelligence Agent Specialization Model (AIAM)

The computing system 1000 may include an AI agent specialization model (AIAM) according to an embodiment of the present disclosure.

The AI agent specialization model (AIAM) according to an embodiment, which is an AI agent model that uses a Mixture of Experts (MoE) architecture implemented according to an embodiment of the present disclosure, may be an artificial intelligence mode including a data processing algorithm configured to autonomously act in specific environments, solve tasks, and achieve goals.

The AI agent specialization model (AIAM) may include a data processing algorithm for implementing a cognitive ability to collect and interpret data from a given environment, a decision mechanism configured to decide an optimal action based on the collected data, an execution ability of executing the decided action, and a learning ability of improving the action through experience.

As an embodiment, the AI agent specialization model (AIAM) may obtain input data (e.g., text, speech, image, video, and/or specific sensor-based sensing data), and based on the obtained input data, perform a task to provide output data (e.g., response data to a specific query and/or a control signal for a specific instruction).

For example, the input data may include a user's query, and the computing system 1000 may identify the user's context based on the query.

The context may include complex information such as the user's previous questions, location, time, and/or preferences.

Accordingly, the computing system 1000 may generate a final response to the query by considering the context described above.

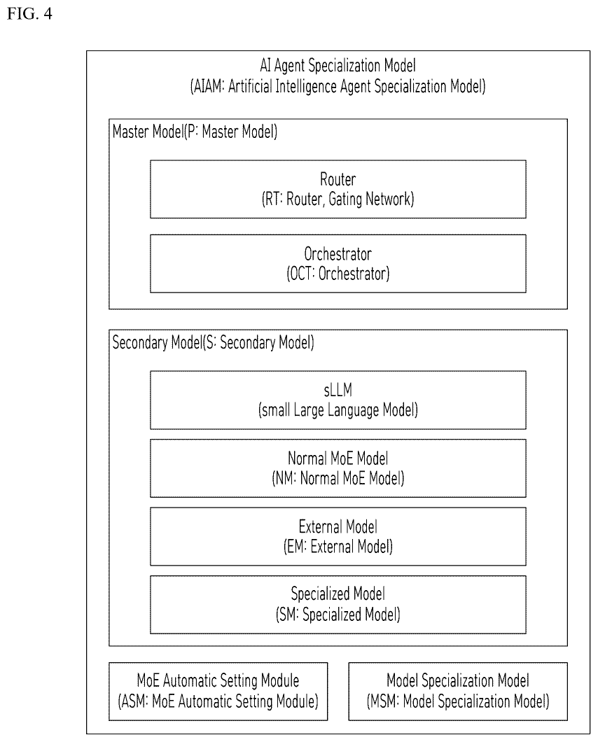

FIG. 4 illustrates a block diagram of an AI agent model according to an embodiment of the present disclosure.

Referring to FIG. 4, the AI agent model according to an embodiment may include one or more of a router (RT) (e.g., a gating network), an orchestrator (OCT), a small large language model (sLLM), a normal MoE model (NM), an external model (EM), and/or a specialized model (SM).

In FIG. 4, the AI agent model may include one or more of the aforementioned components in order to prevent features from being obscured.

However, in certain embodiments, the AI agent model may further include other general-purpose components in addition to one or more components illustrated in FIG. 4, or one or more components illustrated in FIG. 4 may be omitted.

For instance, the router RT (e.g., a gating network) according to an embodiment of the present disclosure may comprise an artificial intelligence module that performs task allocation and/or traffic control for a plurality of models in the MoE architecture.

Specifically, the router RT may analyze input data and/or one or more requested tasks to determine which model is most suitable for processing data.

In one embodiment, the router RT may determine a model optimized for processing given data based on the performance, expertise, and/or previous experience of each model.

Further, the router RT may support efficient data processing by distributing a given task to at least one model by considering system load.

Additionally, the router RT may adjust a task allocated to a specific model by flexibly responding to real-time system changes.

In an embodiment, the router RT may include an artificial intelligence module configured to selectively determine a model (hereinafter, a “domain-specific model”) that executes a data processing operation optimized for a given domain.

That is, in an embodiment, the router RT may comprise an artificial intelligence module that selects, from among a plurality of models included in the AI agent specialization model (AIAM), a model configured to perform data processing (e.g., deep learning) optimized for a given domain.

For example, the term “domain” may refer to data, a rule, terminology, a problem definition, and/or a process used to perform a task specified by a predetermined AI system.

In an embodiment, the router RT may perform data analysis based on one or more features of given input data (e.g., user input and/or specific sensing data) and/or a requested task, identify data processing features or characteristics optimized for the task based on the data analysis, and detect a predetermined model for implementing these to determine a domain-specific model.

In other words, the router RT according to an embodiment may comprise an artificial intelligence module configured to detect a model which may most effectively perform data processing for a given domain, allocate and distribute the corresponding task processing operation, and manages it.

The router RT according to an embodiment may include a router (RT) pre-trained according to a predetermined algorithm described herein, a router RT additionally trained according to an embodiment of the present disclosure, and/or a router RT newly trained using a new method. A detailed description thereof will be provided in the section of the MoE Model Provision Method below.

Additionally, the router RT according to an embodiment may further perform additional functional operations described in the section of the MoE Model Provision Method Below.

The orchestrator OCT according to an embodiment of the present disclosure may include an artificial intelligence module that comprehensively controls and manages the overall configuration of the AI agent specialization model AIAM.

In detail, in an embodiment, the orchestrator OCT may allocate various tasks generated in an entire system to one or more appropriate resources (e.g., the router RT and/or a predetermined model in an embodiment).

Further, the orchestrator OCT may manage one or more resources, such as an available model and a hardware resource (e.g., a CPU and/or a GPU) to be efficiently used.

Further, the orchestrator OCT may monitor the entire system performance to adjust one or more specific parameters or optimize a network configuration or the like.

Further, the orchestrator OCT may manage the interoperation between a plurality of routers RT and/or models and control data flow and one or more processing processes.

That is, in an embodiment, the orchestrator OCT may perform control and management of the entire system of the AI agent specialization model AIAM, and may serve as a main router RT that controls at least one router RT.

The orchestrator OCT and the router RT according to an embodiment may closely interoperate with each other to support the efficient operation of the MoE system.

Specifically, the orchestrator OCT, as the manager of the entire system, may monitor the performance of the router RT and adjust the strategies of the router RT when necessary.

The router RT may practically execute the allocation of data processing tasks based on one or more instructions from the orchestrator OCT and/or its own algorithm, thereby enabling efficient system control.

In an embodiment, the orchestrator OCT and/or router RT described above may serve as a master model P that controls and manages the overall system and/or another or other components of the AI agent model (e.g., an sLLM, normal MoE model NM, external model EM, and/or specialized model SM).

The small large language model (sLLM) according to an embodiment of the present disclosure may comprise an artificial intelligence module that is implemented as a lightweight version of a large language model (LLM).

That is, the sLLM may comprise an artificial intelligence module that is constructed to implement similar performance to a large-scale model such as an LLM with fewer resources.

In an embodiment, the sLLM may include a MoE model (for instance, an MoELM in an embodiment) based on a combination of a plurality of specialized models SM and a router RT according to an embodiment of the present disclosure, as disclosed in the section of the MoE Model Provision Method. Further, the sLLM may include a MoE model (e.g., a DMoE model in an embodiment) based on a domain-specific specialized model according to an embodiment of the present disclosure, as disclosed in the section of Method for Specifying Model Based on MoE to be described later. A detailed description thereof in the sections of MoE Model Provision Method and Method for Specifying Model Based on MoE.

Additionally, the normal MoE model NM according to an embodiment of the present disclosure may refer to a predetermined MoE model that is implemented based on a disclosed universal method.

By way of example, the normal MoE model NM may include a switch transformer, conditional computation in neural networks, a sparse mixture of experts, and/or Megatron-LM.

Additionally, the external model EM according to an embodiment of the present disclosure may refer to a predetermined artificial intelligence model that is implemented according to various disclosed algorithms.

For example, the external model EM may include ChatGPT, Gemini, and/or Llama.

In an embodiment, the external model EM may be selectively used as necessary to support the processing of a given task.

Additionally, the specialized model SM according to an embodiment of the present disclosure may refer to an artificial intelligence model that is trained for optimization for a specific purpose.

That is, the specialized model SM may comprise an artificial intelligence model that is trained using training data and methods specialized to achieve a predetermined objective.

The specialized model SM according to some embodiments of the present disclosure may correspond to a specific example of an artificial intelligence model to which the technical concept of the present disclosure can be applied.

Accordingly, the specialized model SM according to certain embodiment of the present disclosure may include various artificial intelligence models with varied structures and purposes.

In an embodiment, the specialized model SM may include a predetermined trained sLLM (e.g., a MoELM and/or DMoE model), a normal MoE model NM, and/or an external Model EM. Further, the specialized model SM may include a specialized module model according to an embodiment of the present disclosure, as disclosed in the section of Method for Specifying Model Based on MoE to be described later. A detailed description thereof is provided in the section of Method for Specifying Model Based on MoE.

In an embodiment, the sLLM, normal MoE model NM, external model EM, and/or specialized model SM may be secondary models S capable of performing a specific task under the control and management of the master model P (e. g., orchestrator OCT and/or router RT) of the AI agent model.

### MoE Model Provision Method

Hereinafter, a method for implementing a MoE architecture-based model provision service, in which a computing system 1000 according to an embodiment of the present disclosure provides a MoE (Mixture of Experts) model based on a plurality of independently trained specialized models SM, will be described in detail with reference to the accompanying drawings.

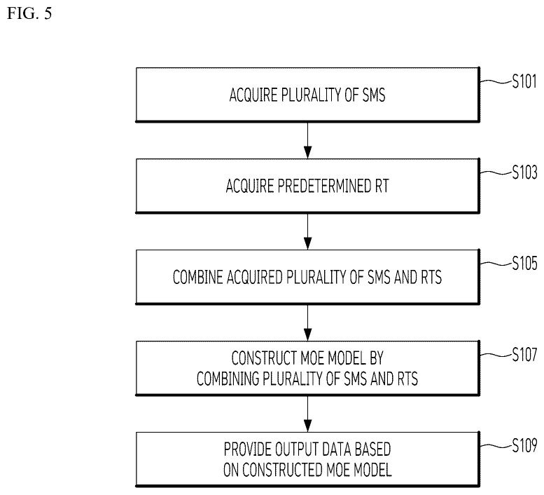

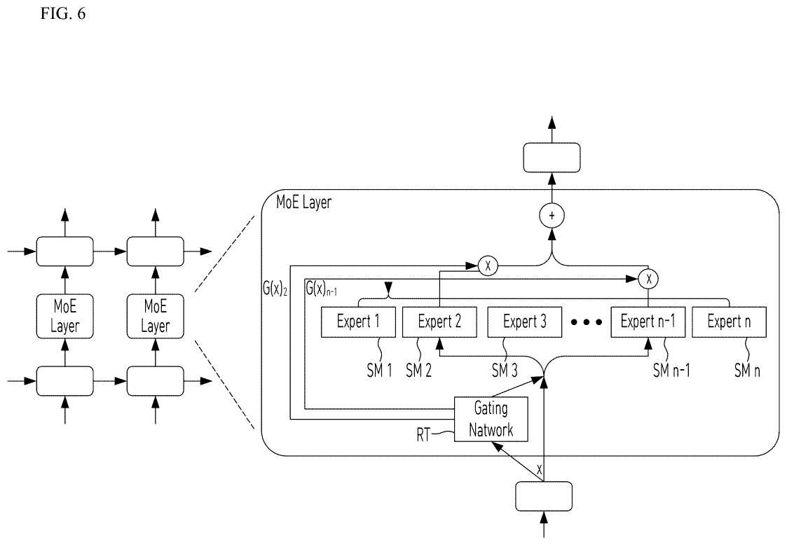

FIG. 5 illustrates a flowchart for explaining a method of providing a MoE model according to an embodiment of the present disclosure, and FIG. 6 illustrates a conceptual diagram for explaining a method of providing a MoE model according t o an embodiment of the present disclosure.

Referring to FIGS. 5 and 6, a method for implementing a MoE architecture-based model provision service, in which the computing system 1000 according to an embodiment of the present disclosure provides a MoE model based on a plurality of pre-trained specialized models SM, may include: step S101 of obtaining a plurality of specialized models SM; step S103 of obtaining a predetermined router RT; step S105 of combining the obtained plurality of specialized models SM and the obtained router RT; step S107 of constructing a MoE model based on the combination of the specialized models SM and the router RT; and step S109 of providing output data based on the constructed MoE model.

At step S101, the computing system 1000 according to an embodiment of the present disclosure may obtain a plurality of specialized models SM.

The specialized model SM according to an embodiment may include an artificial intelligence model that is trained for optimization for a specific purpose, wherein the artificial intelligence model is trained using training data and methods specialized for the specific purpose.

In an embodiment, the specialized model SM may include a predetermined trained sLLM (e.g., a MoELM and/or DMoE model), a normal MoE model NM, an external model EM, and/or a specialized module model according to an embodiment of the present disclosure provided in the section Method for Specifying Model Based on MoE described later.

In an embodiment, the computing system 1000 may obtain the plurality of specialized models SM based on user input and/or through interaction with an external server.

At step S103, the computing system 1000 according to an embodiment of the present disclosure may receive or obtain a predetermined router RT.

Here, the router RT according to an embodiment may comprise an artificial intelligence module that performs task allocation and/or traffic control for a plurality of models within the MoE architecture.

In an embodiment, the computing system 1000 may obtain at least one router RT via user input and/or through interaction with an external server.

The router RT may include a router RT pre-trained according to a predetermined algorithm, a router RT additionally trained according to an embodiment of the present disclosure to be described later, and/or a router RT newly trained using a new method.

At step S105, the computing system 1000 according to an embodiment of the present disclosure may combine the obtained plurality of specialized models SM and the obtained router RT.

In an embodiment, the computing system 1000 may combine a plurality of independently trained specialized models SM and a router RT.

Specifically, in an embodiment, the computing system 1000 may construct a single model (hereinafter, MoELM) that operates together with the MoE architecture of FIG. 6 by adding a router RT to a plurality of specialized models SM.

In other words, the computing system 1000 may configure a third MoE using modularized specialized models SM.

In an embodiment, the computing system 1000 may detect an input data type for each of the plurality of specialized models SM.

Additionally, the computing system 1000 may perform different types of combination processes depending on whether the detected input data types are identical.

For instance, in an embodiment, if the input data types of the plurality of specialized models SM are identical to each other, the computing system 1000 may combine the plurality of specialized models SM and the router RT by using the existing router RT.

Specifically, in an embodiment, the computing system 1000 may combine the plurality of specialized models SM and the router RT by integrating weight values of the existing router RT for each of the specialized models SM through a predetermined computation.

As an embodiment, the computing system 1000 may combine the specialized models SM and the router RT by summing the weight values of the existing routers RT for each of the specialized models SM, for example, but not limited to, by summing the weight values of the existing routers RT for each of the specialized models SM through sampling, and/or by summing the weight values of the existing routers RT for each of the specialized models SM according to a specific formula based on user settings.

Through this, the computing system 1000 may combine the plurality of independently trained specialized models SM and a router RT into one without requiring additional training.

On the other hand, in an embodiment, if the input data types of the specialized models SM are different from each other, the computing system 1000 may additionally train the existing router RT to combine the specialized models SM and the router RT.

Hereinafter, for effective explanation, the plurality of specialized models SM will be described as, but not limited to, a first specialized model SM and a second specialized model SM.

In an embodiment, the computing system 1000 may train the router RT to expand the input data types of the first specialized model SM and the second specialized model SM.

More specifically, the computing system 1000 may integrate the input data for the first specialized model SM and the input data for the second specialized model SM through a predetermined computation, while preserving the original forms of the input data.

Furthermore, the computing system 1000 may train the router RT to use the input data type of the integrated input data as the input data type of the first and second specialized models SM.

In other words, the computing system 1000 may additionally train the router RT to expand the input data types of the first specialized model SM and the second specialized model SM and perform training and operation based on this.

In another embodiment, the computing system 1000 may train the router RT to change the input data types of the first specialized model SM and the second specialized model SM.

Specifically, the computing system 1000 may convert the input data of the first specialized model SM into a weight value to change the input data of the first specialized model SM into the input data type of the second specialized model SM.

Then, the computing system 1000 may train the router RT to train and run th second specialized model SM using the changed data value.

In the same manner, the computing system 1000 may change the input data of the second specialized model SM into the input data type of the first specialized model SM and then train the router RT to train and run the first specialized model SM using the changed input data.

That is, the computing system 1000 may additionally train the router RT to change the input data types of the first specialized model SM and the second specialized model SM and perform training and operation accordingly.

As such, in an embodiment, the computing system 1000 may combine the plurality of specialized models SM and the router RT, by additional training to resolve differences in input data types between the specialized models SM, thereby constructing a combined model (e.g., MoELM) that prevents errors arising from this and performs smoother learning and operation.

In some embodiments, the computing system 1000 may combine the plurality of specialized models SM and the router RT by newly training the existing router RT using a new method.

In detail, in an embodiment, the computing system 1000 may train the router RT to determine which input data should be delivered to which specialized model SM, depending on the input data and/or available resources.

The computing system 1000 may also train the router RT to decide whether to deliver the entire input data or only a portion of the input data.

Furthermore, in an embodiment, the computing system 1000 may train the router RT to determine how many specialized models SM to activate, depending on the input data and/or available resources.

Furthermore, in an embodiment, the computing system 1000 may train the router RT to assess the quality of output data and accordingly decide which input data should be delivered to which specialized model SM.

Furthermore, in an embodiment, the computing system 1000 may train the router RT to assess data processing speed and/or performance and accordingly decide which input data should be delivered to which specialized model SM.

Furthermore, in an embodiment, the computing system 1000 may train the router RT to assess data processing quality according to initial settings and accordingly decide which input data should be delivered to which specialized model SM.

Furthermore, in an embodiment, the computing system 1000 may train the router RT to decide which input data should be delivered to which specialized model SM, based on target performance and data processing speed input by the user.

Furthermore, in an embodiment, the computing system 1000 may train the router RT such that the router RT can identify an optimal specialized model SM and delivers input data to that specialized model SM, based on user feedback, reinforcement learning, LLM-based self-feedback, RLHF, and/or RLAIF.

Referring further to FIG. 4, in some embodiments, the computing system 1000 may further include an artificial intelligence module (hereinafter, a MoE automatic setting module ASM) that learns a predetermined existing MoE architecture and automatically sets a new MoE based on it.

Furthermore, the computing system 1000 may use the MoE automatic setting module ASM to configure the training and operation of the router RT.

Once the MoE automatic setting module ASM completes the settings for the router RT, it may cease performing any further operations.

Additionally, in some embodiments, the computing system 1000 may train the router RT to implement the functional operations of the MoE automatic setting module ASM.

As such, in an embodiment, the computing system 1000 may execute various new router (RT) training processes so that the plurality of specialized models SM and the router RT can be seamlessly combined with each other.

Thus, the computing system 1000 can more reliably ensure the performance and quality of the combined model (e.g., MoELM).

At step S107, the computing system 1000 according to an embodiment of the present disclosure may construct a MoE model by combining the plurality of specialized models SM and the router RT.

That is, in an embodiment, the computing system 1000 may construct a single model (e.g., MoELM) that operates together with the MoE architecture by combining the plurality of specialized models SM and the router RT as described above.

The MoELM may be included in the sLLM according to an embodiment of the present disclosure.

In other words, the sLLM according to an embodiment may include the MoELM constructed according to the embodiment of the present disclosure.

At step S109, the computing system 1000 according to an embodiment of the present disclosure may provide output data based on the constructed MoE model.

In an embodiment, the computing system 1000 may provide output data (e.g., data responding to a specific query and/or a control signal for a specific instruction) for given input data (e.g., text, speech, image, video, and/or specific sensor-based sensing data) by using the MoELM constructed according to an embodiment as above.

As described above, in an embodiment, the computing system 1000 may combine individually trained specialized models SM with a router RT to run them together with the MoE architecture, and may provide output data by the combined model.

In other words, the computing system 1000 may generate and provide output data from task processing based on given input data using a combined model (e.g., MoELM) constructed in the form of a MoE by aggregating independently trained standalone models.

Through this, in an embodiment, the computing system 1000 can implement a MoE mechanism that achieves efficient data processing without unnecessary wasting of resources by utilizing small-sized models optimized for a given task, unlike conventional MoE methods that operate while maintaining large-sized models overall.

Thus, the computing system 1000 can support various services using an improved form of the MoE model that preserves the advantages of conventional MoE approaches (e.g., faster pre-training speed compared to FFN, faster inference speed compared to models of the same size, and/or enhanced instruction tuning performance), while reducing or minimizing disadvantages of the conventional MoE approaches (e.g., high level of necessity of VRAM and/or various challenges during fine-tuning). As a result, the performance and quality of these services can be improved.

### Method for Specifying Model Based on MoE

Hereinafter, a method for implementing a MoE (Mixture of Experts) architecture-based model provision service, in which a computing system 1000 according to an embodiment of the present disclosure implements modularization of a given specialized model SM in a MoE model, will be described in detail with reference to the accompanying drawings.

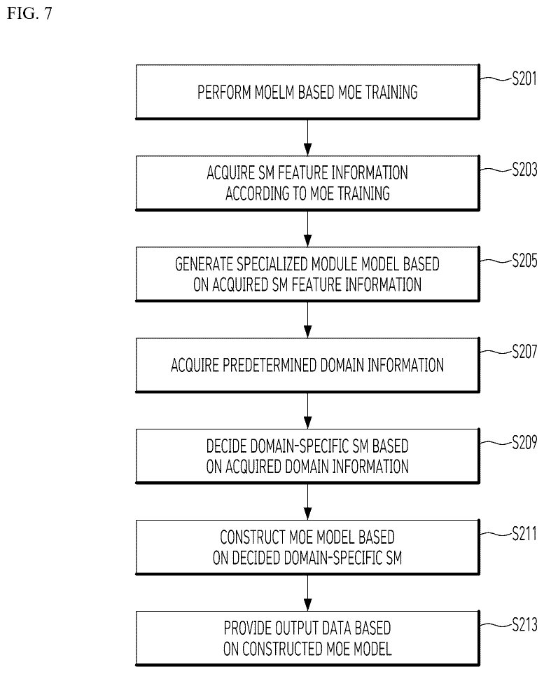

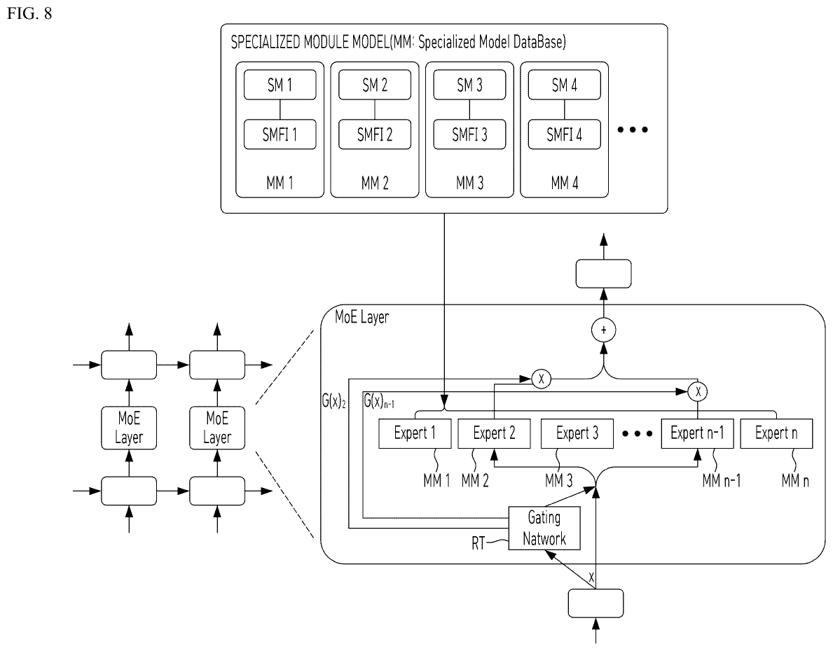

FIG. 7 illustrates a flowchart for explaining a method for specifying a model based on an MoE according to an embodiment of the present disclosure, and FIG. 8 illustrates a conceptual diagram for explaining a method for specifying a model based on an MoE according to an embodiment of the present disclosure.

Referring to FIGS. 7 and 8, a method for implementing a MoE architecture-based model provision service, in which the computing system 1000 according to an embodiment of the present disclosure implements modularization of a specialized model SM included in a MoE model may include step S201 of performing MoE training based on MoELM; step S203 of obtaining specialized model (SM) feature information from the MoE training; step S205 of generating a specialized module model based on the obtained specialized model (SM) feature information; step S207 of obtaining given domain information; step S209 of determining a domain-specific specialized model based on the obtained domain information; step S211 of constructing a MoE model based on the determined domain-specific specialized model; and step S213 of providing output data based on the constructed MoE model.

In conventional technologies, it may be difficult to distinguish or identify which domain a general pre-trained specialized model SM is optimized for.

As a result, certain limitations may arise in selecting and utilizing a specialized model SM that is most optimized for a given task.

To address this issue, in an embodiment of the present disclosure, the computing system 1000 may perform a process for specifying a role and/or function of each specialized model SM, modularizing them, and based on this, effectively selecting and utilizing a customized specialized model SM optimized for a specific domain.

At step S201, the computing system 1000 according to an embodiment of the present disclosure may perform MoE training based on MoELM.

In an embodiment, the computing system 1000 can perform MoE training based on the MoELM constructed according to the section of the MoE model provision method described above.

As the training is performed, the computing system 1000 may implement the training for each of the plurality of specialized models SM included in the MoELM.

In other words, as the training is performed, the plurality of specialized models SM in the MoELM may be individually trained.

Here, the specialized model SM according to an embodiment may refer to an artificial intelligence model that is trained for optimization for a specific purpose, wherein the artificial intelligence model is trained using training data and methods specialized for that specific purpose.

In an embodiment, the specialized models SM may include a predetermined trained sLLM (e.g., a MoELM and/or DMoE model), a normal MoE model NM, an external model EM, and/or a specialized module model MM according to an embodiment of the present disclosure disclosed below.

At S203, the computing system 1000 according to an embodiment of the present disclosure may receive or obtain specialized model feature information SMFI from the MoE training.

Here, the specialized model feature information SMFI according to an embodiment may refer to information that specifies a role and/or function of a given specialized model SM.

In more detail, referring further to FIG. 4, in an embodiment, the computing system 1000 may further include a model specialization module MSM according to an embodiment of the present disclosure.

Further, the computing system 1000 may obtain the specialized model feature information SMFI through interaction with the model specialization module MSM.

Here, the model specialization module MSM according to an embodiment of the present disclosure may include an artificial intelligence module that generates and outputs specialized model feature information SMFI corresponding to a given specialized model SM based on MoE training.

Specifically, in an embodiment, the model specialization module MSM may monitor and track how a task for each specialized model SM is allocated by the router RT when the MoE training is performed.

In an embodiment, the model specialization module MSM may identify which task the router RT distributes and allocates to which specialized model SM as the MoELM is trained and run.

In some embodiments, the model specialization module MSM may generate a tag for specifying each allocated task being tracked and manage how the tag is matched.

Through this, in an embodiment, the model specialization module MSM may assess the expertise of each of the plurality of specialized models SM.

Additionally, in an embodiment, the model specialization module MSM may generate specialized model feature information SMFI corresponding to each specialized model SM, based on the assessed expertise of each specialized model SM.

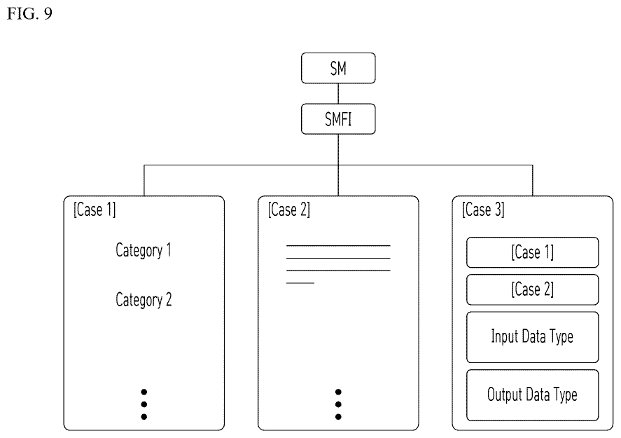

FIG. 9 illustrates an example of specialized model feature information SMFI according to an embodiment of the present disclosure.

Referring to FIG. 9, in an embodiment, the model specialization module MSM may generate the specialized model feature information SMFI in at least one of the following cases:
[Case 1] Specialized model feature information SMFI that selects one category among role-and/or function-specific categories (e.g., query answering or device control) of a preset specialized model SM based on user input.
[Case 2] Specialized model feature information SMFI that specifies a role and/or function of a specialized model SM in natural language.
[Case 3] Specialized model feature information SMFI that specifies a role and/or function of a specialized model SM using at least one of Case 1 and Case 2 and further defines input data and output data of the specialized model SM.

Subsequently, in an embodiment, the model specialization module MSM may provide the generated specialized model feature information SMFI to the computing system 1000 as output data.

Accordingly, in an embodiment, the computing system 1000 may obtain feature information for each specialized model SM through interaction with the model specialization module MSM.

At step S205, the computing system 1000 may generate a specialized module model MM based on the obtained specialized model feature information SMFI.

Here, the specialized module model MM according to an embodiment of the present disclosure may refer to a specialized model SM that is matched with given specialized model feature information SMFI.

Here, the specialized module model MM according to an embodiment of the present disclosure may refer to a specialized model SM that is matched with given specialized model feature information SMFI, and that is independent and discrete.

In detail, in an embodiment, the computing system 1000 may match the specialized model feature information SMFI obtained as described above with the corresponding specialized model SM.

Additionally, in an embodiment, the computing system 1000 may organize each specialized model SM matched with the specialized model feature information SMFI independently and discretely in a database.

In an embodiment, the computing system 1000 may perform modularization by matching each specialized model SM with the corresponding SMFI and storing and managing them separately and discretely.

Accordingly, the computing system 1000 may generate a specialized module model MM, which is a specialized model SM that is matched with the specialized model feature information SMFI, and that is independent and discrete.

As such, in an embodiment, the computing system 1000 can identify a feature of each specialized model SM in a given MoE model (e.g., MoELM in an embodiment) and modularize each specialized model SM into a compact size that allows for reuse and sharing by reflecting the feature.

Therefore, the computing system 1000 can more accurately, quickly, and efficiently sort and select the specialized models SM that implement a data processing process optimized for a specific domain and, based on this, facilitate flexible expansion or reduction of the MoE model.

At step S207, the computing system 1000 according to an embodiment of the present disclosure may obtain given domain information.

Here, the term domain information may refer to, for example, but not limited to, information that defines a domain that specifies data, rules, terminology, problem definitions, and/or processes used by a given AI system to perform a given task.

In an embodiment, the computing system 1000 may obtain given input data (e.g., text, speech, images, video, and/or specific sensor-based sensing data).

Additionally, in an embodiment, the computing system 1000 may identify domain corresponding to the obtained input data.

In an embodiment, the computing system 1000 may perform an operation of identifying a domain for input data based on various algorithms, and the present disclosure is not limited a specific algorithm which can be used.

Accordingly, in an embodiment, the computing system 1000 may obtain domain information for the task to be processed.

At step S209, the computing system 1000 according to an embodiment of the present disclosure may determine a domain-specific specialized model based on the obtained domain information.

Here, the domain-specific specialized model according to an embodiment may comprise a specialized model SM that performs a data processing operation (e.g., deep learning) optimized for a given domain.

In detail, referring further to FIG. 8, in an embodiment, the computing system 1000 may determine at least one domain-specific specialized model based on the domain information and specialized model feature information SMFI obtained as described above.

In more detail, in an embodiment, the computing system 1000 may detect at least one piece of specialized model feature information SMFI that has a feature corresponding to the obtained domain information.

For example, if the computing system 1000 identifies “a feature of a task of outputting response data for given query data” based on first domain information, the computing system 1000 may detect at least one piece of specialized model feature information SMFI from a database of feature information SMFI of a plurality of specialized models, specified as having “a role and/or function specialized in answering queries”.

In some embodiments, the computing system 1000 may detect at least one piece of specialized model feature information SMFI corresponding to the domain information, based on a plurality of tags generated by the model specialization module MSM for each task the router RT allocated to the plurality of specialized models SM, during the above-described MoE architecture-based training.

In some embodiments, the computing system 1000 may detect at least one piece of specialized model feature information SMFI corresponding to the domain information by comparing the domain information with the plurality of tags generated as described above.

In some embodiments, the computing system 1000 may filter the tags to be compared based on the time at which each tag is generated.

Specifically, the computing system 1000 may designate at least one tag generated at a allocation time of a specific task as the tag(s) to be compared, according to user input and/or a preset internal process.

By way of example, the computing system 1000 may designate, as the tag(s) to be compared, at least one tag generated for a task allocated after a preset time during the entire training period, based on the observation that the task allocation accuracy improves as the learning rate increases.

Accordingly, the computing system 1000 may detect at least one piece of specialized model feature information SMFI corresponding to the domain information by comparing the domain information with at least one filtered tag that ensures higher accuracy.

Moreover, in an embodiment, the computing system 1000 may extract a specialized model SM (e.g., a specialized module model MM) matched with each of the detected feature information SMFI of at least one specialized model.

In addition, in an embodiment, the computing system 1000 may determine at least one extracted specialized module model MM as a domain-specific specialized model(s).

At step S211, the computing system 1000 according to an embodiment of the present disclosure may construct a MoE model based on the determined domain-specific specialized model(s).

Referring further to FIG. 8, in an embodiment, the computing system 1000 may construct a single model (hereinafter, DMoE model) that operates together with the MoE architecture based on at least one domain-specific specialized model determined as described above.

In other words, the computing system 1000 may construct a MoE model (e.g., DMoE model) that implements data processing optimized for a specific domain by using at least some (i.e., domain-specific specialized model(s)) of a plurality of specialized models SM modularized in a small size.

In detail, in an embodiment, the computing system 1000 may construct the DMoE model by combining at least one domain-specific specialized model with a predetermined router RT.

In an embodiment, a concrete method in which the computing system 1000 constructs the DMoE model by combining a domain-specific specialized model and a router RT may be performed according to the description of the method for constructing MoELM by combining a plurality of expert models SM and a router RT, as disclosed in the section of MoE Model Provision Method described above.

Accordingly, in an embodiment, the computing system 1000 may construct a DMoE model including a domain-specific specialized models and a router RT.

In some embodiments, the DMoE model may be included in an sLLM.

In other words, the sLLM according to an embodiment may include a DMoE model constructed according to an embodiment of the present disclosure.

At step S213, the computing system 1000 according to an embodiment of the present disclosure may provide output data based on the constructed MoE model.

In an embodiment, the computing system 1000 may provide output data (e.g., data responding to a specific query and/or a control signal for a specific instruction) for given input data (e.g., text, speech, image, video, and/or specific sensor-based sensing data) by using the DMoE model constructed as described above.

In an embodiment, the computing system 1000 may use the DMoE model constructed as described above to process a task that requires compound reasoning, and transmit and provide data output by processing the task to a predetermined user computing device 110.

For example, the computing system 1000 may receive a complex user query through an on-device AI agent, such as “Find a restaurant near my current location that is open now and offers vegetarian options, and provide the optimal route to the one with the highest social media rating.”

Upon receiving such a query that requires compound reasoning, the computing system 1000 may decompose the complex query into logical sub-tasks through the router RT included in the DMoE model-for example, (1) a task of identifying a current location, (2) a task of searching for nearby restaurant information, (3) a task of checking menus and business hours of restaurants, (4) a task of collecting or comparing social media ratings, (5) a task of calculating a route to a final destination, and (6) a task of aggregating all information to generate an answer to a user.

Subsequently, the computing system 1000 may selectively activate one or more of the plurality of specialized models SM based on the characteristics of each sub-task decomposed through the router RT.

For example, the computing system 1000 may sequentially or concurrently assign and operate a ‘location information specialized model’ for obtaining location data, a ‘web search specialized model’ for retrieving restaurant information, a ‘map and route navigation specialized model’ for calculating routes, and a ‘natural language processing sLLM’ for generating a final answer.

The ‘location information specialized model’, ‘web search specialized model’, etc. may correspond to a specific embodiment of the specialized models SM described throughout the detailed description of the present disclosure.

As a concrete example, the plurality of specialized models SM may include various models (e.g., search models) that obtain information from external data sources.

Here, the external data source may refer to any information source outside a model, such as the web, specific databases, APIs, and/or local file systems.

For example, the search model may be an artificial intelligence model that accesses external data sources such as the web, specific databases, APIs, and/or local file systems to retrieve necessary information.

As another example, the plurality of specialized models SM may include various models (e.g., augmentation models) that enhance the generation of the final response using the retrieved information.

For example, the augmentation model may be an artificial intelligence model that performs Retrieval-Augmented Generation (RAG), which improves the accuracy and detail of responses based on the latest information or factual data obtained by the search model.

The computing system 1000 may use a combined model constructed in the form of a MoE by combining independently trained standalone models, to direct the entire reasoning process, such as by transmitting the output of a specialized model SM that has performed one of a plurality of sub-tasks as input into a specialized model SM that has performed a next sub-task, under the control of the router RT and/or the orchestrator OCT.

Accordingly, the computing system 1000 may aggregate the output data from the specialized models SM that have performed the plurality of sub-tasks to generate final output data, thereby providing the result of the complex task to the user.

the method according to the present disclosure is not limited to the aforementioned examples and can be broadly applied to various compound reasoning-based services, such as planning intricate travel itineraries, comparing and recommending products, and conducting multi-criteria searches.

Furthermore, in an embodiment, the computing system 1000 may ingest the final output data (or response) generated as described above into at least one subsequent processing component.

Here, the subsequent processing component may refer to a functional unit that receives data generated by at least one processor and performs predetermined subsequent processing. The subsequent processing component may be implemented in hardware, software, or a combination thereof.

For example, the subsequent processing component may include a user interface generation component for manifesting the output data (or response) through a user interface, a data storage component for storing the output data (or response) in a specific format in a database, and/or a visualization processing component for visualizing the output data (or response).

In some embodiments, the subsequent processing component may process and manifest the output data (or response) in the form of a table and/or graph on a graphical user interface (GUI) of the user computing device 110.

As described above, in an embodiment, the computing system 1000 can specify a role and/or function of each specialized model SM, separate and modularize them individually into a reusable and shareable size, and rapidly and flexibly construct a customized MoE model (e.g., DMoE model) optimized for a specific domain using such a modularized specialized model and provide given output data through efficient task processing using the constructed model.

In other words, in an embodiment, the computing system 1000 can implement and provide a MoE model with enhanced data processing and/or computational speed and improved inference performance and support a variety of services accordingly, thereby effectively promoting improvements in performance and quality.

### Method for Providing AI Agent Based on MoE-Applied LLM

Hereinafter, a method for implementing a MoE architecture-based model provision service, in which a computing system 1000 according to an embodiment of the present disclosure determines an application model optimized for a domain according to an external environment based on a Mixture of Experts (MoE)-applied Large Language Model (LLM) and provides an on-device-specific Artificial Intelligence (AI) agent that performs output based on the determined application model, will be described in detail with reference to the accompanying drawings.

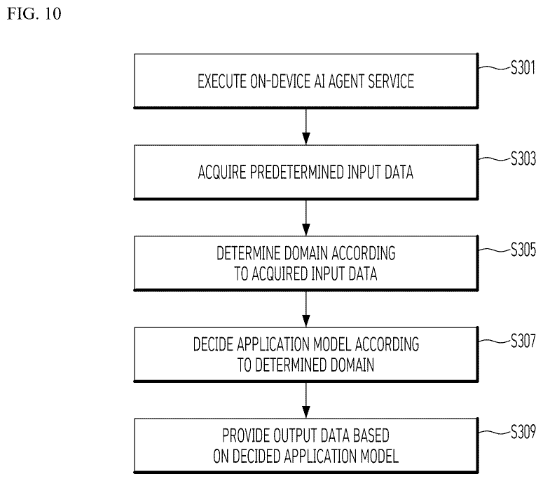

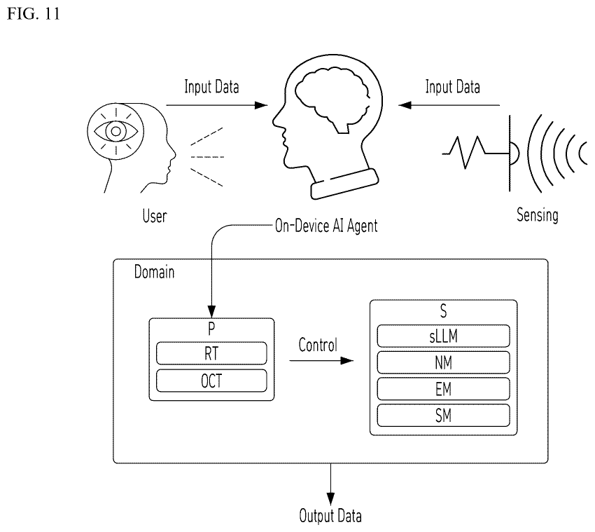

FIG. 10 illustrates a flowchart for explaining a method for providing an AI agent based on a MoE-applied LLM according to an embodiment of the present disclosure, and FIG. 11 shows a conceptual diagram for explaining a method for providing an AI agent based on a MoE-applied LLM according to an embodiment of the present disclosure.

Referring to FIGS. 10 and 11, a method for implementing a MoE architecture-based model provision service, in which the computing system 1000 according to an embodiment of the present disclosure determines an application model optimized for a domain according to an external environment based on a Mixture of Experts (MoE)-applied Large Language Model (LLM) and provides an on-device-specific Artificial Intelligence (AI) agent that performs output based on the determined application model, may include: step S301 of executing an on-device AI agent service; step S303 of obtaining given input data; step S305 of identifying a domain for the obtained input data; step S307 of determining an application model for the identified domain; and step S309 of providing output data based on the determined application model.

At step S301, the computing system 1000 according to an embodiment of the present disclosure may execute an on-device AI agent service.

For instance, the on-device AI may refer to a technology that performs artificial intelligence-based data processing in a device of the user, rather than using relying on one or more cloud or external servers. Since all processing operations are performed or completed in the device without transmitting data externally to the outside of the device, this embodiment may provide personal information protection, real-time processing, and reduced dependency on internet connectivity.

The term on-device AI agent service may refer to various services implemented using on-device AI.

By way of example, the on-device AI agent services may include smartphone voice assistant services (e.g., Google Assistant, Apple Siri, Samsung Bixby, etc.), smart camera services (e.g., Google Pixel's HDR+, Apple's Deep Fusion, etc.), fitness tracker and smartwatch services (e.g., Apple Watch, Fitbit, etc.), autonomous driving systems (e.g., Tesla's Autopilot, etc.), and/or home security services (e.g., Nest Secure, Ring, etc.).

In an embodiment, the computing system 1000 may execute a predetermined on-device AI agent service through interaction with an AI Agent Specialization Model AIAM according to an embodiment of the present disclosure and/or a given application.

At step S303, the computing system 1000 according to an embodiment of the present disclosure may obtain given input data.

In an embodiment, the computing system 1000 may obtain at least one input data (e.g., given text, speech, image, video, and/or sensing data) via user input based on the on-device AI agent service executed as above and/or through interaction with an external device (e.g., a given sensor).

In an embodiment, the input data obtained as above may include given data that can specify a target task for data processing.

At step S305, the computing system 1000 according to an embodiment of the present disclosure may identify a domain for the obtained input data.

For example, the term domain may refer to data, rules, terminology, problem definitions, and/or processes used by a given AI system to perform a given task.

In an embodiment, the computing system 1000 may identify a domain corresponding to the obtained input data.

In this case, in an embodiment, the computing system 1000 may identify domain for input data based on various algorithms, and the present disclosure is not limited to a specific algorithms which can be used.

Accordingly, in an embodiment, the computing system 1000 may obtain domain information for the task to be processed.

At step S307, the computing system 1000 according to an embodiment of the present disclosure may determine an application model for the identified domain.

For example, the term application model may refer to a model that performs a given task based on given input data.

In an embodiment, such an application model may be at least one of the secondary models S described above.

The term secondary model S according to an embodiment may refer to a model capable of performing a specific task under the control and management of a master model P (e.g., an orchestrator OCT and/or router RT) which is responsible for the control and management of a predetermined AI system operation.

In an embodiment, such a secondary model S may include at least one of sLLM (e.g., a MoELM and/or DMoE model), a normal MoE model NM, an external Model EM, and/or a specialized model SM (e.g., a specialized module model MM).

In detail, in an embodiment, the computing system 1000 may determine at least one application model based on the domain information obtained as described above.

More specifically, in an embodiment, the computing system 1000 may detect at least one model (e.g., a domain-specific model) that executes a data processing operation (e.g., deep learning) optimized for given domain information, among the aforementioned secondary models S, by interoperating with a master model P (e.g., an orchestrator OCT and/or router RT) according to an embodiment of the present disclosure.

The description for a concrete method in which the computing system 1000 detects a domain-specific model by interoperating with a master model P will be omitted as the description of the router RT and orchestrator OCT provided in the section of AI Agent Specialization Model (AIAM) described above can be applied.

In an embodiment, the computing system 1000 may determine the at least one detected one domain-specific model as an application model.

At step S309, the computing system 1000 according to an embodiment of the present disclosure may provide output data based on the determined application model.

That is, in an embodiment, the computing system 1000 may generate and provide output data (e.g., data responding to a specific query and/or a control signal for a specific instruction) for given input data (e.g., text, speech, image, video, and/or specific sensor-based sensing data) based on at least one application model determined through the AI agent specialization model AIAM as described above.

In other words, the computing system 1000 may perform a predetermined requested task based on given input data by using the application model determined as above, and may provide output data from the performed data processing.

In an embodiment, the computing system 1000 may provide the output data based on the above-described on-device AI agent service.

As described above, in the embodiment, the computing system 1000 may effectively determine a model optimized for data processing for a given domain even in an on-device environment, based on an AI agent specialization model AIAM including models (e.g., MoEL, DMoE model, and/or specialized module model MM) implemented by using MoE architecture according to an embodiment of the present disclosure, and may provide output by effective data processing through the determined model.

The computing system 1000 may implement and provide an artificial intelligence model (e.g., AI agent specialization model AIAM)) capable of better understanding, interpreting, executing, and responding to a given task in any environment.

Accordingly, in an embodiment, the computing system 1000 may significantly and directly enhance the quality and performance of various AI agent-based services (e.g., smartphone voice assistant services, smart camera services, fitness tracker and smartwatch services, autonomous driving services, and/or home security services).

The embodiments of the present disclosure described above may be implemented in the form of program instructions that can be executed through various computer components and recorded on a computer-readable medium. The computer readable medium may include program instructions, data files, data structures, and the like alone or in combination. The program instructions recorded on the computer-readable recording medium may be specially designed and configured for the present disclosure, or may be known and available to those skilled in computer software. Examples of the computer-readable recording medium include: magnetic media such as hard disks, floppy disks, and magnetic tape; optical media such as CD-ROMs and DVDs; magneto-optical media such as floptical disks; and hardware devices such as ROM, RAM, and flash memory specifically configured to store and execute program instructions. Examples of the program instructions include machine language codes such as those generated by a compiler, as well as high-level language codes that can be e xecuted by a computer using an interpreter or the like. The hardware devices may be configured to act as one or more software modules in order to perform processing according to the present disclosure, and vice versa.

The specific implementations described in the present disclosure are exemplary embodiments, and do not limit the scope of the present disclosure in any way. For brevity of the specification, descriptions of conventional electronic configurations, control systems, software, and other functional aspects of the systems may be omitted. In addition, the connections or connection members of lines between the components shown in the drawings are illustrative examples of functional connections and/or physical or circuit connections, and in actual devices, may be shown as alternative or additional various functional connections, physical connections, or circuit connections. In addition, unless specifically mentioned, such as “essential”, “importantly”, etc., the components described herein may not be necessary components for application of the present disclosure.

Furthermore, although the detailed description of the present disclosure has been provided with reference to preferred embodiments of this disclosure, those skilled in the art or having ordinary knowledge in the relevant technical field will understand that the present disclosure may be variously modified and changed without departing from the spirit and scope of the disclosure as defined in the claims that follow. Accordingly, the technical scope of the present disclosure should not be limited to the content described in the detailed description of the specification, but should be defined by the scope of the appended claims.

Some embodiments the present disclosure may relate to a method and system for specifying a model based on an artificial intelligence model including a plurality of models, and therefore have industrial applicability since they are applicable to the artificial intelligence industry.

What is claimed is:

1. A computer-implemented method comprising:
by at least one processor, receiving domain information and storing the received domain information in at least one memory;
detecting, by the at least one processor, from the at least one memory, specialized model feature information including a feature corresponding to the domain information stored in the at least one memory, wherein the specialized model feature information specifies a feature of each of a plurality of artificial intelligence models which are independently pre-trained,
extracting, by the at least one processor, at least one artificial intelligence model corresponding to the detected specialized model feature information among the plurality of artificial intelligence models, wherein each of the at least one artificial intelligence model is matched with the specialized model feature information based on a task allocated for each of the plurality of artificial intelligence models by at least one router which is an artificial intelligence module configured to control a model task;
combining, by the at least one processor, the extracted at least one artificial intelligence model and at least one artificial intelligence model including the at least one router to generate at least one combined artificial intelligence model;
activating, by the at least one processor, an artificial intelligence model corresponding to given input data among the plurality of artificial intelligence models based on the at least one combined artificial intelligence model; and
generating, by the at least one processor, output data corresponding to the input data based on the activated artificial intelligence model.

2. The computer-implemented method of claim 1, further comprising:
training, by the at least one processor, the plurality of artificial intelligence models and the at least one artificial intelligence model including the at least one router;
monitoring, by the at least one processor, allocation of a task for each of a plurality of specialized models by the at least one router when the plurality of artificial intelligence models and the at least one artificial intelligence model including the at least one router are trained; and
obtaining, by the at least one processor, the specialized model feature information for each of the plurality of artificial intelligence models based on the monitored allocation of the task for each of the plurality of specialized models.

3. The computer-implemented method of claim 1, wherein the specialized model feature information includes information which specifies one of preset specialized model feature categories based on user input.

4. The computer-implemented method of claim 1, wherein the specialized model feature information includes information which specifies a feature of each of the plurality of artificial intelligence models.

5. The computer-implemented method of claim 1, wherein the specialized model feature information includes at least one of first type information specifying one of preset specialized model feature categories based on user input, second type information specifying a feature of each of the plurality of artificial intelligence models in natural language, and third type information specifying input data and output data of each of the plurality of artificial intelligence models.

6. The computer-implemented method of claim 2, further comprising:
matching, by the at least one processor, the obtained specialized model feature information with an artificial intelligence model corresponding to the obtained specialized model feature information among the plurality of artificial intelligence models; and
generating, by the at least one processor, a database by organizing the artificial intelligence model matched with the obtained specialized model feature information.

7. The computer-implemented method of claim 1, wherein the domain information defines a domain that specifies at least one feature among data, rules, terminology, problem definitions, and processes for a given task.

8. The computer-implemented method of claim 2, wherein:
the obtaining of the specialized model feature information comprises generating a tag for specifying each task allocated by the at least one router, and
the detecting of the specialized model feature information including the feature corresponding to the domain information comprises comparing the generated tag with the domain information to detect the specialized model feature information including the feature corresponding to the domain information.

9. The computer-implemented method of claim 8, wherein the detecting of the specialized model feature information having the feature corresponding to the domain information from the at least one memory further comprises filtering the generated tag based on a time associated with generation of the tag.

10. The computer-implemented method of claim 1, wherein the generating of the output data comprises:
operating the activated artificial intelligence model to perform the task by the at least one router based on the input data;
storing a plurality of output data based on the operated activated artificial intelligence model in the at least one memory; and
combining the plurality of output data stored in the at least one memory to generate the output data corresponding to the input data.

11. The computer-implemented method of claim 1, further comprising:
storing, by the at least one processor, the generated output data in the at least memory;
ingesting, by the at least one processor, the output data stored in the at least o memory into at least one of an on-device model and an external model accessed via a network; and
manifesting, by the at least one processor, the output data on at least one interface.

12. The computer-implemented method of claim 11, wherein the ingesting of the output data comprises controlling the at least one router to ingest the output data into at least one of the on-device model and the external model accessed via the network, by considering system load or available resources associated with the task based on the input data.

13. The computer-implemented method of claim 11, wherein, in response to a query requiring compound reasoning, the at least one router decomposes the query into a plurality of sub-tasks, and activates one of the plurality of artificial intelligence models based on characteristics of each of the decomposed sub-tasks.

14. The computer-implemented method of claim 13, wherein
the manifesting of output data on the at least one interface comprises:
transmitting output of an artificial intelligence model that has performed one of the plurality of sub-tasks, among the plurality of artificial intelligence models, as input into an artificial intelligence model that has performed a next one of the plurality of sub-tasks, among the plurality of artificial intelligence models; and
aggregating data output from artificial intelligence models that have performed the plurality of sub-tasks to generate the output data.

15. The computer-implemented method of claim 1, wherein the plurality of artificial intelligence models includes one or more of: at least one search model retrieving information from one or more external data sources, or at least one augmentation model enhancing generation of the output data.

16. A system comprising:
memory configured to store executable instructions; and
one or mor processors configured to execute one or more of the instructions to perform operations comprising:
receiving domain information and storing the received domain information in the memory;
detecting, from the memory, specialized model feature information including a feature corresponding to the domain information stored in the memory, wherein the specialized model feature information specifies a feature of each of a plurality of artificial intelligence models which are independently pre-trained,
extracting at least one artificial intelligence model corresponding to the detected specialized model feature information among the plurality of artificial intelligence models, wherein each of the at least one artificial intelligence model is matched with the specialized model feature information based on a task allocated for each of the plurality of artificial intelligence models by at least one router which is an artificial intelligence module configured to control a model task;
combining the extracted at least one artificial intelligence model and at least one artificial intelligence model including the at least one router to generate at least one combined artificial intelligence model;
activating an artificial intelligence model corresponding to given input data among the plurality of artificial intelligence models based on the at least one combined artificial intelligence model; and
generating output data corresponding to the input data based on the activated artificial intelligence model.

17. The system of claim 16, wherein the operations further include:
storing the generated output data in the memory;
ingesting the output data stored in the memory into at least one of an on-device model and an external model accessed via a network; and
manifesting the output data on at least one interface through the at least one subsequent processing component.
